(19) United States
(12) Patent Application Publication
(10) Pub. No.: US 2026/0126953 A1
(43) Pub. Date: May 7, 2026

(54) SYSTEM AND METHOD OF ENABLING DIGITAL PHOTO FRAME WITH VOICE INTERACTION AND INTELLIGENCE GENERATION FUNCTIONS

(71) Applicants: SQ Technology (Shanghai) Corporation, Shanghai (CN); Inventec Corporation, Taipei (TW)

(72) Inventors: Chuan-Cheng CHIU, Taipei (TW); Hong FU, Shanghai (CN); Zhuo-Jia BIAN, Shanghai (CN)

(73) Assignees: SQ Technology (Shanghai) Corporation, Shanghai (CN); Inventec Corporation, Taipei (TW)

(21) Appl. No.: 19/021,168

(22) Filed: Jan. 15, 2025

(30) Foreign Application Priority Data
Nov. 1, 2024 (CN) 2024115572685

(51) Int. Cl. G06F 3/16; G06F 40/40; G06T 11/60; G06T 19/20; G10L 15/22; G10L 15/26; H04N 13/302; H04N 13/398

(52) U.S. Cl. CPC G06F 3/167; G06F 40/40; G06T 11/60; G06T 19/20; G10L 15/22; G10L 2015/223; G10L 15/26; H04N 13/302; H04N 13/398

(57) ABSTRACT

A system of enabling digital photo frame with voice interaction and intelligence generation and a method thereof are provided. In the system, a digital photo frame provides an interaction voice to an image edition and modification server, which uses a speech-to-text technology to convert the interaction voice to a text message and provides the text message to an artificial intelligence (AI) platform through an application programming interface (API), the AI platform transmits back a text response containing an execution instruction; the image edition and modification server uses an artificial general intelligence (AGI) to execute the execution instruction, obtain a digital image from the digital photo frame, and edit or/and modify to form an edited digital image; based on the multimodal information contained in the edited digital image, the digital photo frame displays and plays the edited digital image based on the multimodal information contained in the edited digital image.

### BACKGROUND OF THE INVENTION

### 1. Field of the Invention

The present invention relates to an interaction and generation system and a method thereof, particularly to a system of enabling digital photo frame with voice interaction and intelligence generation that provides voice interaction and AI-based intelligent to generate an edited/modified digital image, and a method thereof.

### 2. Description of the Related Art

A digital photo frame is an electronic device designed specifically to display a digital image. In addition to displaying a single digital image, the digital photo frame allows the selection of some or all digital images and displays the selected digital images in a loop or randomly based on a set time interval. Therefore, the digital photo frame necessarily provides an operational interface.

With technological advancements, the integration of various industries with artificial intelligence (AI) has become the main direction of current industry development. If AI can be integrated with the digital photo frame, in addition to the general configuration features of the digital photo frame, the digital photo frame can further have diverse intelligent functions such as annotation, classification, selection, display settings, and AI edition and modification in the backend. It is obvious that the digital photo frame can be improved with AI.

According to above-mentioned contents, what is needed is to develop an improved solution to the problem that the existing digital photo frames only provide overly monotonous and simple operations.

### SUMMARY OF THE INVENTION

An objective of the present invention is to disclose a system of enabling digital photo frame with voice interaction and intelligence generation and a method thereof, to solve the problem that the existing digital photo frames only provide overly monotonous and simple operations.

To achieve the objective, the present invention discloses a system of enabling digital photo frame with voice interaction and intelligence generation, and the system includes a digital photo frame, an AI platform and an image edition and modification server. The image edition and modification server includes a non-transitory computer readable storage medium and a hardware processor.

The digital photo frame is configured to obtain an interaction voice through a microphone device which is embedded in the digital photo frame or externally connected to the digital photo frame, provide the interaction voice, obtain at least one edited digital image, and display the at least one edited digital image based on multimodal information contained in the at least one edited digital image, or display the at least one edited digital image based on the multimodal information contained in the at least one edited digital image and play the at least one edited digital image based on the multimodal information through a speaker device which is embedded in the digital photo frame or externally connected to the digital photo frame.

The AI platform is configured to obtain a text message through an application programming interface (API), provide the text message to a large language model to generate a text response containing at least one execution instruction, and transmit back the text response through the API.

The non-transitory computer readable storage medium is configured to store computer readable instructions. The hardware processor is electrically connected to the non-transitory computer readable storage medium, and configured to execute the computer readable instruction to make the image edition and modification server operate: obtaining the interaction voice from the digital photo frame; using the speech-to-text technology to convert the interaction voice of voice modal into the text message of text modal; providing the text message to the AI platform through the API, and obtain the text response through the API; using an artificial general intelligence (AGI) to execute the at least one execution instruction contained in the text response to obtain at least one digital image from the digital photo frame and edit or modify the obtained digital image to form at least one edited digital, or obtain the at least one digital image from the digital photo frame and edit and modify the obtained digital image to form the at least one edited digital; providing the at least one edited digital image to the digital photo frame.

To achieve the objective, the present invention discloses a method of enabling digital photo frame with voice interaction and intelligence generation, and the method comprises steps of: obtaining an interaction voice through a microphone device which is embedded in the digital photo frame or externally connected to the digital photo frame, and providing the interaction voice to an image edition and modification server, by a digital photo frame; using a speech-to-text technology to convert the interaction voice of voice modal into a text message of text modal, by the image edition and modification server; providing the text message to an AI platform through an API, by the image edition and modification server; providing the text message to a large language model to generate a text response containing at least one execution instruction, by the AI platform; transmitting back the text response to the image edition and modification server through the API, by the AI platform; using an AGI to execute the at least one execution instruction contained in the text response, obtaining at least one digital image from the digital photo frame, and editing or modifying the at least one digital image to form at least one at least one edited digital image, or obtaining the at least one digital image from the digital photo frame, and editing and modifying the at least one digital image to form the at least one edited digital image, by the image edition and modification server; providing the at least one edited digital image to the digital photo frame, by the image edition and modification server; based on the multimodal information contained in the at least one edited digital image, displaying the at least one edited digital image, or displaying at least one edited digital image and playing the at least one edited digital image through a speaker device which is embedded in the digital photo frame or externally connected to the digital photo frame, by the digital photo frame.

According to the system and method of the present invention, the digital photo frame provides the interaction voice to the image edition and modification server, the image edition and modification server uses the speech-to-text technology to convert the interaction voice to the text message, the image edition and modification server provides the text message to the AI platform through the API, the AI platform transmits back the text response containing the execution instruction; the image edition and modification server uses the AGI to execute the execution instruction contained in the text response, obtain the digital image from the digital photo frame, and edit or/and modify to form the at least one edited digital image; based on the multimodal information contained in the at least one edited digital image, the digital photo frame displays the edited digital image, the digital photo frame displays and plays the edited digital image based on the multimodal information contained in the at least one edited digital image.

Therefore, the above-mentioned solution of the present invention can achieve the technical effect of providing voice interaction and intelligent edition and modification to generate a digital image.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a system of enabling digital photo frame with voice interaction and intelligence generation functions, according to the present invention.

FIG. 2 is a schematic view of an architecture of a digital photo frame having speech interaction and intelligent generation functions, according to the present invention.

FIG. 3A and FIG. 3B are flowcharts of a method of enabling a digital photo frame with voice interaction and intelligence generation functions, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

As used herein, the term “or” includes any and all combinations of one or more of the associated listed items. It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

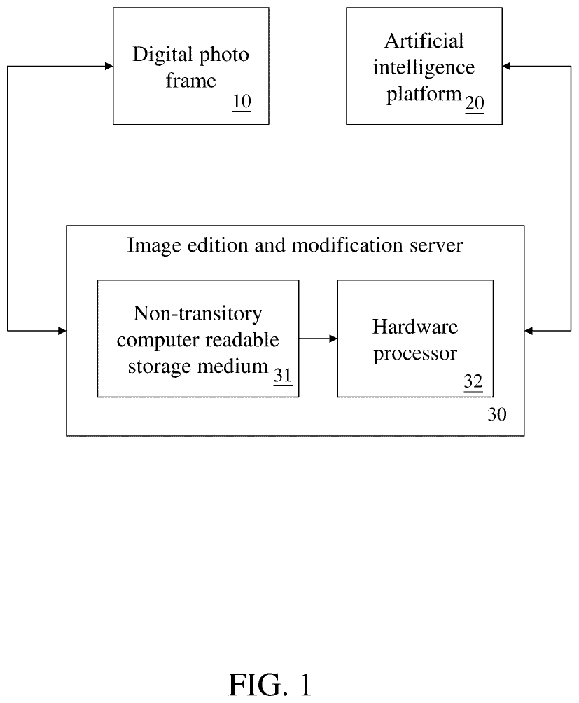

The system of enabling a digital photo frame with voice interaction and intelligence generation functions of the present invention will be illustrated in the following paragraphs. Please refer to FIG. 1. FIG. 1 is a block diagram of a system of enabling digital photo frame with voice interaction and intelligence generation functions, according to the present invention.

The system of the present invention includes a digital photo frame 10, an AI platform 20 and an image edition and modification server 30. The image edition and modification server 30 includes a non-transitory computer readable storage medium 31 and a hardware processor 32.

The digital photo frame 10 is an electronic device specifically used to display a digital image. The digital image displayed by the digital photo frame 10 is stored in a memory of the digital photo frame 10. The digital photo frame 10 can be electrically connected to an external universal serial bus (USB) device or a secure digital (SD) card, thereby displaying digital images stored in the USB device or the SD card. The digital photo frame 10 can be connected to a cloud device via wired or wireless transmission manner, thereby displaying digital images stored in the cloud device.

In an embodiment, the memory can be a random-access memory (RAM), which includes static random-access memory (SRAM) and dynamic random-access memory (DRAM). The USB device can be a storage device implementing hot-swapping technology through the universal serial bus. The aforementioned SD card can be a SD card, a miniSD card, or a microSD card. The aforementioned wired transmission manner can include a cable network or an optical fiber network, etc. The wireless transmission manner can include Wi-Fi or mobile communication network (e.g., 3G, 4G, 5G, etc.), these examples are merely for exemplary explanation, and the application field of the present invention is not limited to these examples.

With technological advancements, the digital photo frame 10 can utilize autostereoscopic 3D display technology to present 3D images, that is, multilayer optical structure or parallax barrier technology are used to provide a user with different views from different angles, to create a stereoscopic visual effect. The digital photo frame 10 in combination with 3D glasses can enable a user to see a 3D image with a depth and distance of objects. However, these examples are merely for exemplary explanation, and the application field of the present invention is not limited to these examples.

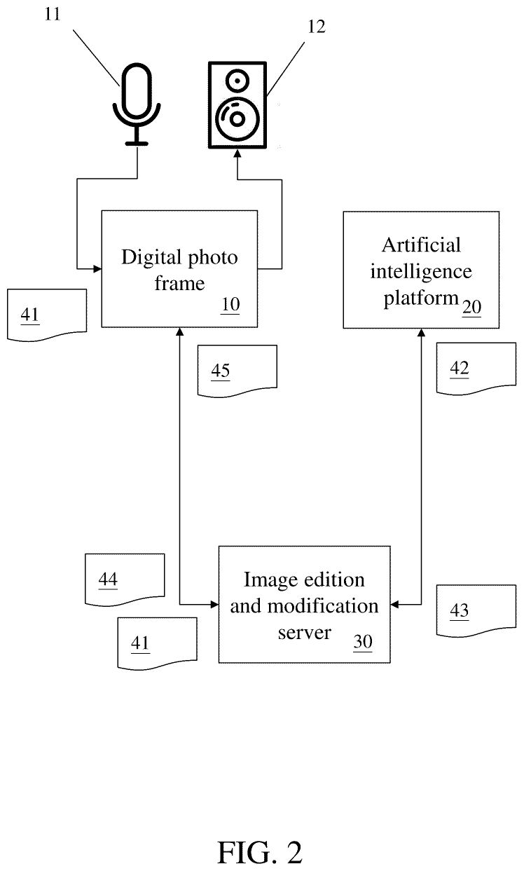

Please refer to FIG. 2. FIG. 2 is a schematic view of an architecture of a digital photo frame having speech interaction and intelligent generation functions, according to the present invention. The digital photo frame 10 obtains an interaction voice through a microphone device 11 which is embedded in the digital photo frame 10 or externally connected to the digital photo frame 10. In FIG. 2, the microphone device 11 connected externally to the digital photo frame 10 is used as an example, the present invention is not limited to above-mentioned examples. The digital photo frame 10 can obtain an interaction voice 41 that the operator wants to edit or modify through the microphone device 11, or the digital photo frame 10 can obtain the interaction voice 41 that the operator wants to edit and modify through the microphone device 11. The digital photo frame 10 is connected to the AI platform 20 and the image edition and modification server 30, respectively, via wired or wireless transmission manner, so that the digital photo frame 10 can provide the interaction voice 41 obtained by the microphone device 11 to the image edition and modification server 30.

The non-transitory computer readable storage medium 31 of the image edition and modification server 30 stores computer readable instructions. A hardware processor 32 of the image edition and modification server 30 is electrically connected to the non-transitory computer readable storage medium 31 and executes the computer readable instructions to make the image edition and modification server 30 perform the following operations.

After obtaining the interaction voice 41 from the digital photo frame 10, the image edition and modification server 30 uses a speech-to-text technology to convert the interaction voice 41 of voice modal into a text message 42 of text modal. The speech-to-text technology converts the voice signal into texts through an acoustic model and a language models, for example, the interaction voice 41 is first converted into phonemes (the smallest phonetic unit in language) through the acoustic model, and the language model uses context and grammatical rules to predict an order in which words corresponding to phonemes will appear, to improve the conversion accuracy of generating the text message 42 of text modal. Specifically, in a condition that the interaction voices 41 of voice modal is “Please remove the background from the image named 20241001 and save it, the saved file name is 20241001_Image_Matting,” the speech-to-text technology can convert the interaction voice 41 “Please remove the background from the image named 20241001 and save it, the saved file name is 20241001_Image_Matting,” into the text message 42 of text modal, as “Please remove the background from the image named 20241001 and save it, the saved file name is 20241001_Image_Matting”.

The image edition and modification server 30 provides the text message 42 to the AI platform 20 through an API, and the AI platform 20 obtains the text message 42 through the API from the image edition and modification server 30 and provides the text message 42 to a large language model to generate a text response 43 that contains at least one execution instruction. The AI platform 20 then transmits back the text response 43 to the image edition and modification server 30 through the API. The large language model can be, for example, generative pretrained transformer (GPT), bidirectional encoder representations from transformers (BART), or contrastive language-Image pre-training (CLIP), but these examples are merely for exemplary explanation, and the application field of the present invention is not limited to these examples.

Continuing with the example, according to the text message 42 “Please remove the background from the image named 20241001 and save it, the saved file name is 20241001_Image_Matting,” the AI platform 20 can generate the execution instructions “obtain the image named 20241001 from the digital photo frame 10”, “remove the background from the image named 20241001,” and “save the modified image as 20241001_Image_Matting”. However, these examples are merely for exemplary explanation, and the application field of the present invention is not limited to these examples.

After the image edition and modification server 30 obtains the text response 43 from the AI platform 20 through the API, the image edition and modification server 30 uses an AGI to execute the at least one at least one execution instruction contained in the text response 43, to obtain at least one digital image 44 from the digital photo frame 10 and edit or modify the at least one digital image 44 to form the at least one at least one edited digital image 45, or obtain the at least one digital image 44 from the digital photo frame 10 and edit and modify the at least one digital image 44 to form at least one edited digital image 45. The edition or modification performed on the digital image 44 or the edition and modification performed on the digital image 44 can be annotating the digital image 44, classifying the digital image 44, selecting multiple images for continuous display, adding a background music to the selected images, or performing AI edition or modification (e.g., grayscale processing, background removal, adding artistic text to images) on specific or multiple images based on the execution instruction. However, these examples are merely for exemplary explanation, and the application field of the present invention is not limited to these examples.

Specifically, the image edition and modification server 30 uses the AGI to perform the following operations. First, the digital image 44 with the file name “20241001” is obtained from the digital photo frame 10, the background is then removed from the digital image 44 with the file name “20241001”, the image with the file name “20241001_Image_Matting” is saved as an edited digital image 45 after the background removal is completed for the digital image 44 with the file name “20241001”. However, these examples are merely for exemplary explanation, and the application field of the present invention is not limited to these examples.

The AGI refers to AI with human-equivalent or surpassing human intelligence. The AGI exhibits high flexibility, learning ability, and reasoning ability across various tasks, not limited to specific domains or tasks, and has broad application potential and the capability to solve diverse problems. In contrast, narrow AI can only target specific domains or tasks and lacks general-purpose capability.

The feature of AGI lies in its ability to flexibly apply learned knowledge across different domains or tasks, like human cross-domain adaptability in various tasks. The AGI is capable of self-learning and enhancing its knowledge and abilities without relying on specific algorithms or predetermined procedures, and understands language, reasoning, planning, and problem-solving without the need for prior design or explicit instructions. Thus, the AGI can be used to edit or modify at least one digital image 44 to form the at least one edited digital image 45, or edit and modify the at least one digital image 44 to form the at least one edited digital image 45.

It is worth noting that when the at least one digital image 44 is a three-dimensional digital image, the AGI can select a 3D modeling tool, which was used to create the at least one at least one digital image 44, to edit or modify the at least one digital image 44 to form the at least one edited digital image 45, or edit and modify the at least one digital image 44 to form the at least one edited digital image 45. The 3D modeling tool can be, for example, Blender or 3D version of Photoshop, but these examples are merely for exemplary explanation, and the application field of the present invention is not limited to these examples.

The image edition and modification server 30 then provides the at least one edited digital image 45 to the digital photo frame 10, the digital photo frame 10 obtains the at least one edited digital image 45 from the image edition and modification server 30, and displays the edited digital image 45 based on multimodal information contained in the edited digital image, or the digital photo frame 10 obtains the at least one edited digital image 45 from the image edition and modification server 30, and displays and plays the at least one edited digital image 45 based on multimodal information contained in the edited digital image through the speaker device 12, which is embedded in the digital photo frame 10 or externally connected to the digital photo frame 10. As shown in FIG. 2, the speaker device 12 connected externally to the digital photo frame 10 is used as an example, but the present invention is not limited to above-mentioned examples. Specifically, in a condition that the edited digital image 45 includes a 3D text of text modal, background music of music modal, the digital photo frame 10 can play the background music while displaying the edited digital image 45, and the 3D text of text modal is simultaneously displayed on the edited digital image 45 of image modal displayed on the digital photo frame 10, thereby achieving multimodal display, or display and playback. However, these examples are merely for exemplary explanation, and the application field of the present invention is not limited to these examples. In an embodiment, when the digital photo frame 10 is a 3D digital photo frame, the digital photo frame 10 can provide an operator to rotate or move the at least one digital image 44 or the at least one edited digital image 45 by touch or gesture control, so that the digital photo frame 10 can have interactive functionality.

It is to be particularly noted that, in actual implementation, the above-mentioned solution of the present invention can be implemented fully or partly based on hardware, for example, at least one component of the system can be implemented by integrated circuit chip, system on chip (SoC), a complex programmable logic device (CPLD), or a field programmable gate array (FPGA). The non-transitory computer-readable storage medium of the present invention records computer readable program instructions, and the processor can execute the computer readable program instructions to implement concepts of the present invention. The non-transitory computer-readable storage medium can be a tangible apparatus for holding and storing the instructions executable of an instruction executing apparatus. The non-transitory computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the non-transitory computer-readable storage medium can include a hard disk, an RAM memory, a read-only-memory, a flash memory, an optical disk, a floppy disc, or any appropriate combination thereof, but this exemplary list is not an exhaustive list. The non-transitory computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the non-transitory computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network and forward the computer readable program instruction to store in non-transitory computer-readable storage medium of each calculating/processing apparatus. The computer readable instructions for implementing the operations of the present invention can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages.

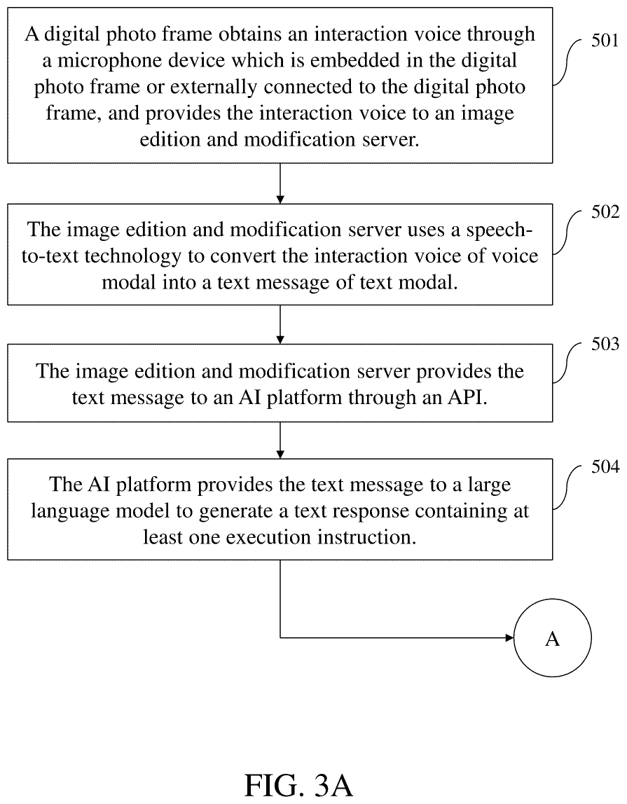

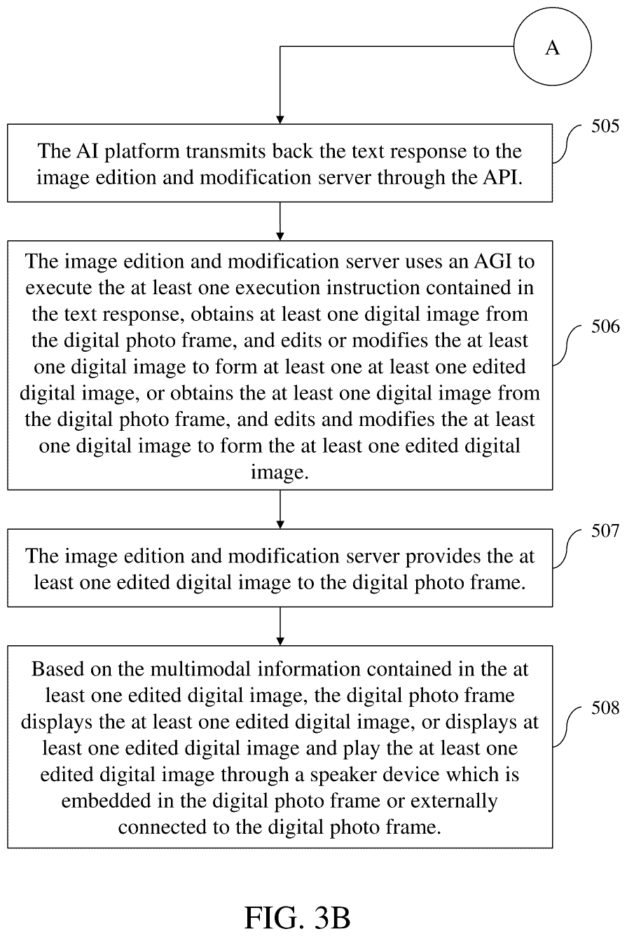

The operation of a method of the present invention will be illustrated in the following paragraphs, please refer to FIG. 3A and FIG. 3B. FIG. 3A and FIG. 3B are flowcharts of a method of enabling digital photo frame with voice interaction and intelligence generation functions, according to the present invention.

As shown in FIG. 3A and FIG. 3B, the method of the present invention includes the following steps.

In a step 501, a digital photo frame obtains an interaction voice through a microphone device which is embedded in the digital photo frame or externally connected to the digital photo frame, and provides the interaction voice to an image edition and modification server. In a step 502, the image edition and modification server uses a speech-to-text technology to convert the interaction voice of voice modal into a text message of text modal. In a step 503, the image edition and modification server provides the text message to an AI platform through an API. In a step 504, the AI platform provides the text message to a large language model to generate a text response containing at least one execution instruction. In a step 505, the AI platform transmits back the text response to the image edition and modification server through the API. In a step 506, the image edition and modification server uses an AGI to execute the at least one execution instruction contained in the text response, obtains at least one digital image from the digital photo frame, and edits or modifies the at least one digital image to form at least one at least one edited digital image, or obtains the at least one digital image from the digital photo frame, and edits and modifies the at least one digital image to form the at least one edited digital image. In a step 507, the image edition and modification server provides the at least one edited digital image to the digital photo frame. In a step 508, based on the multimodal information contained in the at least one edited digital image, the digital photo frame displays the at least one edited digital image, or displays at least one edited digital image and play the at least one edited digital image through a speaker device which is embedded in the digital photo frame or externally connected to the digital photo frame.

According to above-mentioned contents, the digital photo frame provides the interaction voice to the image edition and modification server, the image edition and modification server uses the speech-to-text technology to convert the interaction voice to the text message, the image edition and modification server provides the text message to the AI platform through the API, the AI platform transmits back the text response containing the execution instruction; the image edition and modification server uses the AGI to execute the execution instruction contained in the text response, obtain the digital image from the digital photo frame, and edit or/and modify to form the at least one edited digital image; based on the multimodal information contained in the at least one edited digital image, the digital photo frame displays the edited digital image, the digital photo frame displays and plays the edited digital image based on the multimodal information contained in the at least one edited digital image.

Therefore, the above-mentioned solution of the present invention can solve the problem that the existing digital photo frames only provide overly monotonous and simple operations. and achieve the technical effect of providing voice interaction and intelligent edition and modification to generate a digital image.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A system of enabling a digital photo frame with voice interaction and intelligence generation functions, comprising:
a digital photo frame, configured to obtain an interaction voice through a microphone device which is embedded in the digital photo frame or externally connected to the digital photo frame, provide the interaction voice, obtain at least one edited digital image, and display the at least one edited digital image based on multimodal information contained in the at least one edited digital image, or display the at least one edited digital image based on the multimodal information contained in the at least one edited digital image and play the at least one edited digital image based on the multimodal information through a speaker device which is embedded in the digital photo frame or externally connected to the digital photo frame;
an artificial intelligence (AI) platform, configure to obtain a text message through an application programming interface (API), provide the text message to a large language model to generate a text response containing at least one execution instruction, and transmit back the text response through the API; and
an image edition and modification server, comprises:
a non-transitory computer readable storage medium, configured to store computer readable instructions; and
a hardware processor, electrically connected to the non-transitory computer readable storage medium, and configured to execute the computer readable instruction to make the image edition and modification server operate:
obtaining the interaction voice from the digital photo frame;
using the speech-to-text technology to convert the interaction voice of voice modal into the text message of text modal;
providing the text message to the AI platform through the API, and obtain the text response through the API;
using an artificial general intelligence (AGI) to execute the at least one execution instruction contained in the text response to obtain at least one digital image from the digital photo frame and edit or modify the obtained digital image to form at least one edited digital, or obtain the at least one digital image from the digital photo frame and edit and modify the obtained digital image to form the at least one edited digital; and
providing the at least one edited digital image to the digital photo frame.

2. The system of enabling digital photo frame with voice interaction and intelligence generation functions according to claim 1, wherein when the at least one digital image is a three-dimensional digital image, the AGI selects a 3D modeling tool which was used to create the at least one digital image, to edit or modify the at least one digital image to form the at least one edited digital image, or edit and modify the at least one digital image to form the at least one edited digital image.

3. The system of enabling digital photo frame with voice interaction and intelligence generation functions according to claim 1, wherein the obtaining the at least one digital image from the digital photo frame and editing or modify the at least one digital image to form the at least one edited digital image, or editing and modify the at least one digital image to form the at least one edited digital image, comprises:
performing annotation, classification, selection, display setting, background music adding or AI edition on the at least one digital image to edit or modify the at least one digital image to form the at least one edited digital image, or edit and modify the at least one digital image to form the at least one edited digital image.

4. The system of enabling digital photo frame with voice interaction and intelligence generation functions according to claim 1, wherein when the digital photo frame is a 3D digital photo frame, the 3D digital photo frame provides an operator to control to rotate or move the at least one digital image or the at least one edited digital image through touch control or gesture control.

5. A method of enabling digital photo frame with voice interaction and intelligence generation functions, comprising:
obtaining an interaction voice through a microphone device which is embedded in the digital photo frame or externally connected to the digital photo frame, and providing the interaction voice to an image edition and modification server, by a digital photo frame;
using a speech-to-text technology to convert the interaction voice of voice modal into a text message of text modal, by the image edition and modification server;
providing the text message to an AI platform through an API, by the image edition and modification server;
providing the text message to a large language model to generate a text response containing at least one execution instruction, by the AI platform;
transmitting back the text response to the image edition and modification server through the API, by the AI platform;
using an AGI to execute the at least one execution instruction contained in the text response, obtaining at least one digital image from the digital photo frame, and editing or modifying the at least one digital image to form at least one at least one edited digital image, or obtaining the at least one digital image from the digital photo frame, and editing and modifying the at least one digital image to form the at least one edited digital image, by the image edition and modification server;
providing the at least one edited digital image to the digital photo frame, by the image edition and modification server; and
based on the multimodal information contained in the at least one edited digital image, displaying the at least one edited digital image, or displaying at least one edited digital image and playing the at least one edited digital image through a speaker device which is embedded in the digital photo frame or externally connected to the digital photo frame, by the digital photo frame.

6. The method of enabling digital photo frame with voice interaction and intelligence generation according to claim 5, wherein when the at least one digital image is a three-dimensional digital image, the AGI selects a 3D modeling tool which was used to create the at least one digital image, to edit or modify the at least one digital image to form the at least one edited digital image, or edit and modify the at least one digital image to form the at least one edited digital image.

7. The method of enabling digital photo frame with voice interaction and intelligence generation according to claim 5, wherein the obtaining the at least one digital image from the digital photo frame and editing or modify the at least one digital image to form the at least one edited digital image, or editing and modify the at least one digital image to form the at least one edited digital image, comprises:
performing annotation, classification, selection, display setting, background music adding or AI edition on the at least one digital image to edit or modify the at least one digital image to form the at least one edited digital image, or edit and modify the at least one digital image to form the at least one edited digital image.

8. The method of enabling digital photo frame with voice interaction and intelligence generation according to claim 5, wherein when the digital photo frame is a 3D digital photo frame, the 3D digital photo frame provides an operator to control to rotate or move the at least one digital image or the at least one edited digital image through touch control or gesture control.
